(19) United States
(12) Patent Application Publication
(10) Pub. No.: US 2025/0199424 A1
(43) Pub. Date: Jun. 19, 2025

(54) TONER

(71) Applicant: ZEON CORPORATION, Tokyo (JP)

(72) Inventor: Takeshi Hirata, Tokyo (JP)

(73) Assignee: ZEON CORPORATION, Tokyo (JP)

(21) Appl. No.: 18/849,661

(22) PCT Filed: Mar. 17, 2023
(86) PCT No.: PCT/JP2023/010529

§ 371 Date: Sep. 23, 2024

(30) Foreign Application Priority Data
Mar. 28, 2022 (JP) 2022-051045

(51) Int. Cl. G03G 9/08

(52) U.S. Cl. CPC G03G 9/0819; G03G 9/0827

(57) ABSTRACT

To provide a toner which hardly causes toner leakage and which is excellent in thin line reproducibility. A toner comprising colored resin particles containing a binder resin, a colorant and a release agent, and an external additive, wherein an equivalent circular area diameter is 5.0 μm or more and 10.0 um or less, and a compactness obtained as a ratio of an equivalent circular area diameter to a maximum length (the equivalent circular area diameter/the maximum length) is 0.915 or more and 1.000 or less, both of which are measured by a flow particle image analyzer.

### TECHNICAL FIELD

The present disclosure relates to a toner which is used to develop an electrostatic latent image in, for example, electrophotography, electrostatic recording, and electrostatic printing.

### BACKGROUND ART

In an image forming device such as an electronic photographic device, an electrostatic recording device and an electrostatic printing device, first, an electrostatic latent image formed on the photoconductor is developed using a toner; the toner image is transferred onto a transferring material such as a sheet of paper; and the material is heated to fix the image, thereby obtaining a fixed image.

As such an image forming device, those corresponding to high image quality and high-speed printing are desired, and there are many demands on toners. Especially, there is a strong demand for solving so-called “toner leakage”, which is a phenomenon that toner leaks from a cartridge, since it disturbs continuous printing and leads to a toner loss.

As a method for suppressing toner leakage, Patent Document 1 discloses controlling the value of bulk density after conditioning, which is a value obtained by use of a powder flowability analyzer, within a specific range by adjusting the type of an external additive, the conditions of an external addition treatment, etc.

Patent Document 2 discloses a toner obtained as follows: oil droplets are formed by dispersing, in an aqueous medium, a toner forming material solution containing a polyester segment, a cross-linking agent (a molecular elongation agent), a colorant, a solvent and so on; polyester resin fine particles are formed by molecular elongation within the oil droplets; colored particles are formed by coagulating the polyester resin fine particles in the aqueous medium; and then external additives are added to the colored particles, thereby obtaining the toner.

To improve thin line reproducibility in printing, Patent Documents 1 and 2 disclose the use of a toner having an average circularity of nearly 1.

### CITATION LIST

### Patent Documents

Patent Document 1: International Publication No. WO2018/061933
Patent Document 2: International Publication No. WO2010/001825

### SUMMARY OF INVENTION

### Technical Problem

In the toner leakage suppressing method disclosed in Patent Document 1, however, toner leakage may occur after the lapse of a long period of time in a high temperature and high humidity environment, and there is a demand for further toner leakage suppression. In addition, there is a demand for further improvement in thin line reproducibility since, even when the circularity of the toner is close to 1, sufficient thin line reproducibility cannot be obtained in continuous printing.

An object of the present disclosure is to provide a toner which hardly causes toner leakage and which is excellent in thin line reproducibility.

### Solution to Problem

As a result of diligent research, the inventor of the present disclosure found that by controlling the size and microscopic shape of toner particles, toner leakage can be suppressed, and thin line reproducibility can be improved.

The toner of the present disclosure is a toner comprising colored resin particles containing a binder resin, a colorant and a release agent, and an external additive, wherein an equivalent circular area diameter is 5.0 μm or more and 10.0 μm or less, and a compactness obtained as a ratio of an equivalent circular area diameter to a maximum length (the equivalent circular area diameter/the maximum length) is 0.915 or more and 1.000 or less, both of which are measured by a flow particle image analyzer.

In the toner of the present disclosure, a ratio of a maximum inscribed circle diameter to an equivalent circular area diameter (the maximum inscribed circle diameter/the equivalent circular area diameter) may be 0.900 or more and 0.950 or less.

In the toner of the present disclosure, a circularity may be 0.900 or more and 0.950 or less.

In the toner of the present disclosure, inorganic fine particles having a number average primary particle diameter of from 6 nm to 100 nm and organic fine particles may be contained as the external additive, and a content of the organic fine particles may be 0.05 parts by mass or more and 1.0 part by mass or less, with respect to 100 parts by mass of the colored resin particles.

In the toner of the present disclosure, a content of the inorganic fine particles having a number average primary particle diameter of from 6 nm to 100 nm may be 0.5 parts by mass or more and 6.5 parts by mass or less, with respect to 100 parts by mass of the colored resin particles.

In the toner of the present disclosure, the inorganic fine particles having a number average primary particle diameter of from 6 nm to 100 nm may contain two or more kinds selected from the group consisting of inorganic fine particles A having a number average primary particle diameter of from 36 nm to 100 nm, inorganic fine particles B having a number average primary particle diameter of from 15 nm to 35 nm, and inorganic fine particles C having a number average primary particle diameter of from 6 nm to 14 nm.

### Advantageous Effects of Invention

A toner can be provided by the present disclosure as described above, which can suppress toner leakage for a long period of time in a high temperature and high humidity environment, and which can provide excellent thin line reproducibility in continuous printing.

### DESCRIPTION OF EMBODIMENTS

The toner of the present disclosure is a toner comprising colored resin particles containing a binder resin, a colorant and a release agent, and an external additive,
wherein an equivalent circular area diameter is 5.0 μm or more and 10.0 μm or less, and a compactness obtained as a ratio of an equivalent circular area diameter to a maximum length (the equivalent circular area diameter/the maximum length) is 0.915 or more and 1.000 or less, both of which are measured by a flow particle image analyzer.

For the purpose of improving thin line reproducibility, first, it is important for toner particles to have a sufficiently small size. Moreover, Patent Document 1 explains that from the viewpoint of thin line reproducibility, the circularity of a toner is preferably from 0.96 to 1.00. Patent Document explains that from the viewpoint of thin line reproducibility, the circularity of a toner is preferably from 0.950 to 0.980. The thin line reproducibility of a toner improves as the circularity approaches 1. However, there are limitations on the improvement of thin line reproducibility by the control of the circularity.

The term “circularity” is defined as a value obtained by dividing the equivalent circular area diameter which is the diameter of a circle having the same area as the projected image of a particle, by the equivalent circular perimeter diameter which is the diameter of a circle having the same perimeter as the projected image of the particle. The circularity is 1 when the particle is perfectly spherical, and it gets smaller as the surface shape of the particle becomes more complex. Accordingly, the circularity can be used as an index of the degree of the surface roughness of the particle. When a particle has a microscopically spherical shape, the circularity decreases as the degree of the surface roughness increases. When a particle has a microscopically flat shape, the circularity increases as the degree of the surface roughness decreases. It is difficult to eliminate toner particles having a microscopically flat shape, even when the circularity of the toner is made closer to 1. In the toner production method described in Patent Document 2, the color particles, which will be toner mother particles, are formed by coagulating the polyester resin fine particles, therefore, it is difficult to make the shape of the toner particles close to a spherical shape, and the toner of Patent Document 2 is estimated to contain relatively large amounts of toner particles having a microscopically flat shape. In a toner having a circularity that is controlled to be close to 1, toner particles having a microscopically flat shape are estimated to deteriorate the thin line reproducibility of the toner. Especially, the thin line reproducibility tends to deteriorate as the number of continuously printed sheets increases.

Meanwhile, in the toner of the present disclosure, the equivalent circular area diameter is 10.0 μm or less, and the toner particles are not too large; moreover, the compactness is 0.915 or more, and the microscopic shape of the toner particles is close to a sphere. Accordingly, it is estimated that the thin line reproducibility can be more improved compared to the case where the circularity of the toner is controlled.

The compactness is defined as a value obtained by dividing the equivalent circular area diameter of a particle by the maximum length thereof, that is, as the ratio of the equivalent circular area diameter to the maximum length (the equivalent circular area diameter/the maximum length). The maximum length of a particle is the maximum length between two points on the profile of a projected image of the particle. When the particle is a perfect sphere, the compactness is 1. As the microscopic shape of the particle is distorted to increase the aspect ratio, the compactness value decreases. Since the compactness is less susceptible to the influence of the degree of the surface roughness of the particle, it can be used as an index of the microscopic shape of a particle. Even when the degree of the surface roughness is large, the compactness increases if the microscopic shape is close to a sphere. Even when the degree of the surface roughness is small, the compactness decreases if the microscopic shape is flat and the aspect ratio is large. Since the toner of the present disclosure has a compactness of 0.915 or more and 1.000 or less, the proportion of the toner particles having a flat shape is small.

Also, it is estimated that the toner particles having a flat shape contribute to toner leakage. Since the toner particles having a flat shape are likely to deposit, when such toner particles are contained in the toner, an aggregate of the toner particles is likely to be formed. For example, the aggregate thus formed may penetrate the seal portions at both ends of a developing roller and may form a gap in the seal portions. In addition, as the particle diameter of the toner particles decreases, the toner is more likely to leak from the gap formed in the seal portions, and toner leakage is likely to occur,

In “Examples” of Patent Document 1, it is shown that no toner leakage was observed within a toner leakage test of 16 hours, that was carried out in a high temperature and high humidity environment. However, the toner of the present disclosure can suppress toner leakage for a longer period of time. It is estimated that toner leakage can be suppressed for a longer period of time since, in the toner of the present disclosure, the amount of the toner particles having a flat shape is reduced compared to the toner of Patent Document 1. As described above, it is estimated that the toner disclosed in Patent Document 2 contains large amounts of toner particles having a microscopically flat shape, and it is estimated that an aggregate of toner particles is likely to be formed, and toner leakage is likely to occur, accordingly.

Meanwhile, the compactness of the toner of the present disclosure is 0.915 or more, and the microscopic shape of the toner particles is close to a sphere. Accordingly, it is estimated that an aggregate of the toner particles is less likely to be formed. In addition, it is estimated that since the equivalent circular area diameter is 5.0 μm or more and the toner particles are not too small, toner leakage is less likely to occur even when a small gap is formed in the seal portions. Accordingly, toner leakage is less likely to occur.

Also in the toner of the present disclosure, when the circularity is 0.900 or more and 0.950 or less, toner leakage can be further suppressed. When toners having the same compactness and different circularities are compared, as the circularity increases, the surface roughness of the toner particles decreases. Accordingly, the van der Waals force between the toner particles increases. As a result, the cohesion of the toner increases, and an aggregate is likely to be formed. When an aggregate of the toner particles is formed, as described above, the aggregate forms a gap in the seal portions, which leads to toner leakage. When the compactness is 0.915 or more and 1.000 or less and high, and when the circularity is 0.900 or more and 0.950 or less and appropriately low, the microscopic shape of the toner particles is close to a sphere, and the surface of the toner particles has moderate surface roughness. Such toner particles are less likely to deposit, and the van der Waals force between the particles is low; therefore, the cohesion further decreases. Accordingly, the formation of the aggregate of the toner particles is suppressed, and toner leakage is much more suppressed.

Hereinafter, the size and shape of the toner, which are characteristics of the toner of the present disclosure, will be described. Then, the method for producing the toner of the present disclosure and the performance of the toner of the present disclosure will be described in this order.

In the present disclosure, “to” in a numerical range is used to describe a range in which the numerical values described before and after “to” indicate the lower limit value and the upper limit value.

### 1. Size and Shape of the Toner

In the present disclosure, each of the parameters relating to the size and shape of the toner is the average of the values of randomly selected 1000 to 3000 toner particles, which are measured by use of a flow particle image analyzer with an image resolution of 0.185 μm/pixel.

As the flow particle image analyzer, for example, IF-3200 (product name, manufactured by JASCO International Co., Ltd.) is preferably used. measurement sample is prepared by, for example, performing a dispersion treatment of a mixture liquid, which is obtained by adding 0.10 g to 0.12 g of the toner to an aqueous solution of linear alkylbenzene sulfonate (concentration 0.3%), in an ultrasonic cleaner for 5 minutes.

The equivalent circular area diameter of the toner of the present disclosure is 5.0 μm or more and 10.0 μm or less. From the viewpoint of suppressing toner leakage, the equivalent circular area diameter is preferably 6.0 μm or more, and more preferably 7.0 μm or more. From the viewpoint of improving thin line reproducibility, it is preferably 9.5 μm or less, more preferably 9.0 μm or less, and still more preferably 8.0 μm or less.

When the toner of the present disclosure is a toner obtained by suspension polymerization, the equivalent circular area diameter of the obtained toner can be adjusted by, for example, adjusting the type and amount of an added dispersion stabilizer, adjusting a dispersion treatment time in the formation of droplets, and so on.

The compactness of the toner of the present disclosure is 0.915 or more and 1.000 or less. From the viewpoint of suppressing toner leakage and improving thin line reproducibility, the compactness is preferably 0.920 or more, more preferably 0.925 or more, and still more preferably 0.930 or more. From the viewpoint of ease of production, it is preferably 0.990 or less, more preferably 0.980 or less, and still more preferably 0.970 or less.

When the toner of the present disclosure is a toner obtained by suspension polymerization, the compactness of the toner is easily influenced by the conditions of the polymerization reaction. Accordingly, the compactness of the obtained toner can be adjusted by, for example, adjusting the conditions of the stirring of the suspension just before the suspension is subjected to the polymerization reaction, adjusting the temperature increase rate of the polymerization reaction to adjust the time of the state which is in the middle of the polymerization reaction and in which the particle shape can change, and so on.

As with the compactness of the toner, the ratio of the maximum inscribed circle diameter to the equivalent circular area diameter (the maximum inscribed circle diameter/the equivalent circular area diameter) can be also used as an index of the microscopic shape of the particle, since it is less susceptible to the influence of the degree of the surface roughness of the particle. As for the toner, the maximum inscribed circle diameter is the diameter of a circle having the maximum area among the circles that can be included in a projected image of the toner particle. When the particle is a perfect sphere, the maximum inscribed circle diameter/the equivalent circular area diameter ratio is 1. As the microscopic shape of the particles is distorted to increase the aspect ratio, the value of the maximum inscribed circle diameter/equivalent circular area diameter ratio decreases. Even when the degree of the surface roughness is large, the maximum inscribed circle diameter/equivalent circular area diameter ratio increases if the microscopic shape is close to a sphere. Even when the degree of the surface roughness is small, the maximum inscribed circle diameter/equivalent circular area diameter ratio decreases if the microscopic shape is flat and the aspect ratio increases.

The maximum inscribed circle diameter/equivalent circular area diameter ratio of the toner of the present disclosure is not particularly limited. From the viewpoint of suppressing toner leakage and improving thin line reproducibility, the ratio is preferably 0.900 or more, more preferably 0.905 or more, and still more preferably 0.910 or more. The upper limit of the maximum inscribed circle diameter/equivalent circular area diameter ratio of the toner of the present disclosure may be 1.000 or less, and it is not particularly limited. From the viewpoint of ease of production, the upper limit of the ratio is preferably 0.980 or less, more preferably 0.960 or less, and still more preferably 0.950 or less.

When the toner of the present disclosure is a toner obtained by suspension polymerization, the maximum inscribed circle diameter/equivalent circular area diameter ratio of the toner is easily by influenced the conditions of the polymerization reaction. Accordingly, the maximum inscribed circle diameter/equivalent circular area diameter ratio of the obtained toner can be adjusted by, for example, adjusting the conditions of the stirring of the suspension just before the suspension is subjected to the polymerization reaction, adjusting the temperature increase rate of the polymerization reaction to adjust the time of the state which is in the middle of the polymerization reaction and in which the particle shape can change, and so on.

The circularity of the toner of the present disclosure is not particularly limited. From the viewpoint of suppressing toner leakage, the circularity is preferably 0.950 or less, more preferably less than 0.950, and still more preferably 0.945 or less. From the viewpoint of suppressing the deterioration of the toner leakage suppressing effect and from the viewpoint of suppressing the deterioration of thin line reproducibility, the circularity is preferably 0.900 or more, more preferably 0.910 or more, still more preferably 0.920 or more, and even more preferably 0.930 or more.

### 2. Method for Producing the Toner

The toner of the present disclosure can be obtained by performing an external addition treatment, in which the external additive is mixed and stirred with the colored resin particles containing the binder resin, the colorant and the release agent, to add the external additive on the surface of the colored resin particles.

Hereinafter, the method for producing the colored resin particles and the method of the external addition treatment will be described in order.

### <Method for Producing the Colored Resin Particles>

For example, the colored resin particles contained in the toner of the present disclosure are produced by suspension polymerization, through the following steps.

### (1) Preparation Step of Polymerizable Monomer Composition

First, a polymerizable monomer, a colorant, a release agent and, if necessary, other additives such as a charge control agent and a molecular weight modifier are mixed to prepare a polymerizable monomer composition. In the preparation of the polymerizable monomer composition, for example, the mixing is carried out at a temperature of from 35° C. to 55° C., by use of a dispersing machine such as an in-line type emulsifying and dispersing machine and a media type emulsifying and dispersing machine.

In the present disclosure, the polymerizable monomer is a monomer having a polymerizable functional group. Polymerizable monomers are polymerized to become a binder resin. As the main component of the polymerizable monomer, a monovinyl monomer is preferably used. Examples of the monovinyl monomer include, but are not limited to, styrene; styrene derivatives such as vinyltoluene and α-methylstyrene; acrylic acid and methacrylic acid; acrylic esters such as methyl acrylate, ethyl acrylate, propyl acrylate, butyl acrylate, 2-ethylhexyl acrylate and dimethylaminoethyl acrylate; methacrylic esters such as methyl methacrylate, ethyl methacrylate, propyl methacrylate, butyl methacrylate, 2-ethylhexyl methacrylate and dimethylaminoethyl methacrylate; nitrile compounds such as acrylonitrile and methacrylonitrile; amide compounds such as acrylamide and methacrylamide; and olefins such as ethylene, propylene and butylene. The monovinyl monomers may be used alone or in combination of two or more thereof. Of them, styrene, styrene derivatives, acrylic esters and methacrylic esters are preferred as the monovinyl monomer.

To improve hot offset resistance and storage stability, an optional crosslinkable polymerizable monomer is preferably used in combination with the monovinyl monomer. The crosslinkable polymerizable monomer is a monomer having two or more polymerizable functional groups. Examples of the crosslinkable polymerizable monomer include, but are not limited to, aromatic divinyl compounds such as divinyl benzene, divinyl naphthalene and derivatives thereof; ester compounds such as ethylene glycol dimethacrylate and diethylene glycol dimethacrylate, in which two or more carboxylic acids having a carbon-carbon double bond are esterified to an alcohol having two or more hydroxyl groups; other divinyl compounds such as N, N-divinylaniline and divinyl ether; and compounds having three or more vinyl groups. The crosslinkable polymerizable monomers may be used alone or in combination of two or more thereof.

When the polymerizable monomer includes the crosslinkable polymerizable monomer, the content of the crosslinkable polymerizable monomer is not particularly limited. With respect to 100 parts by mass of the monovinyl monomer, the content of the crosslinkable polymerizable monomer is generally from 0.1 parts by mass to 5 parts by mass, and preferably from 0.3 parts by mass to 2 parts by mass.

In addition, a macromonomer is preferably used as a part of the polymerizable monomer, since the balance between the storage stability and low-temperature fixability of the toner can be improved.

As the macromonomer, examples include a reactive oligomer or polymer which has a polymerizable carbon-carbon unsaturated double bond at the end of the molecular chain and which has a number average molecular weight of generally from 1,000 to 30,000. As the macromonomer, examples include a styrene macromonomer, a styrene-acrylonitrile macromonomer, polyacrylic ester macromonomer and a polymethacrylic ester macromonomer. Among them,, at least one selected from polyacrylic ester macromonomer or a polymethacrylic ester macromonomer is preferably used. As the acrylic ester used in the polyacrylic ester macromonomer, examples include the above-mentioned acrylic esters usable as the monovinyl monomer. As the methacrylic ester used in the polymethacrylic ester macromonomer, examples include the above-mentioned methacrylic esters usable as the monovinyl monomer. As the macromonomer, it is preferable to appropriately select and such use a macromonomer, that when the polymerizable monomer includes the macromonomer, the glass transition temperature (Tg) of the obtained binder resin becomes higher than the case where the polymerizable monomer does not include the macromonomer.

As the macromonomer, a commercially-available product may be used. Examples of the commercially-available product of the macromonomer include macromonomer series AA-6, AS-6, AN-6S, AB-6 and AW-6S manufactured by Toagosei Co., Ltd.

The macromonomers may be used alone or in combination of two or more thereof.

When the polymerizable monomer includes the macromonomer, the content of the macromonomer is not particularly limited. The content of the macromonomer is preferably from 0.03 parts by mass to 5 parts by mass, and more preferably from 0.05 parts by mass to 1 part by mass, with respect to 100 parts by mass of the monovinyl monomer.

The content of the polymerizable monomer is not particularly limited. The content of the polymerizable monomer is preferably from 60 parts by to 95 parts by mass, more preferably from 65 parts by mass to 90 parts by mass, and still more preferably from 70 parts by mass to 85 parts by mass, with respect to 100 parts by mass of the total solid content contained in the polymerizable monomer composition.

In the present disclosure, a “solid content” means all components other than solvents, and liquid monomers and the like are included in the “solid content”.

As the colorant, a colorant conventionally used in toners can be appropriately selected and used. The colorant is not particularly limited. When producing a color toner, a black colorant, a cyan colorant, a yellow colorant or a magenta colorant can be used.

Examples of the black colorant include carbon black, titanium black and magnetic powder such as zinc-iron oxide and nickel-iron oxide.

Examples of the cyan colorant include cyan pigments such as phthalocyanine pigments (e.g., copper phthalocyanine pigments and derivatives thereof) and anthraquinone pigments, and cyan dyes. The specific examples include C.I. Pigment Blue 2, 3, 6, 15, 15:1, 15:2, 15:3, 15:4, 16, 17:1 and 60, and C.I. Solvent Blue 70.

Examples of the yellow colorant include yellow pigments such as azo-based pigments (e.g., monoazo pigments and disazo pigments) and condensed polycyclic pigments, and yellow dyes. The specific examples include C.I. Pigment Yellow 3, 12, 13, 14, 15, 17, 62, 65, 73, 74, 83, 93, 97, 120, 138, 155, 180, 181, 185, 186, 213 and 214, and C.I. Solvent Yellow 98 and 162.

Examples of the magenta colorant include magenta pigments such as azo-based pigments (e.g., monoazo pigments and disazo pigments) and condensed polycyclic pigments (e.g., quinacridone pigments), and magenta dyes. The specific examples include C.I. Pigment Red 31, 48, 57:1, 58, 60, 63, 64, 68, 81, 83, 87, 88, 89, 90, 112, 114, 122, 123, 144, 146, 149, 150, 163, 170, 184, 185, 187, 202, 206, 207, 209, 237, 238, 251, 254, 255 and 269; C.I. Pigment Violet 19; C.I. Solvent Red 1, 3, 8, 23, 24, 25, 27, 30, 49, 81, 82, 83, 84, 100, 109 and 121; C.I. Disperse Red 9; C.I. Solvent Violet 8, 13, 14, 21 and 27; C.I. Disperse Violet 1; C.I. Basic Red 1, 2, 9, 12, 13, 14, 15, 17, 18, 22, 23, 24, 27, 29, 32, 34, 35, 36, 37, 38, 39 and 40; and C.I. Basic Violet 1, 3, 7, 10, 14, 15, 21, 25, 26, 27 and 28.

The colorants may be used alone or in combination of two or more thereof.

The content of the colorant is not particularly limited. From the viewpoint of obtaining sufficient image density, the content of the colorant is preferably from 5 parts by mass to 15 parts by mass, and more preferably from 7 parts by mass to 13 parts by mass, with respect to 100 parts by mass of the polymerizable monomer. Also, the content of the colorant in the toner is preferably from 5 parts by mass to 15 parts by mass, and more preferably from 7 parts by mass to 13 parts by mass, with respect to 100 parts by mass of the binder resin.

The polymerizable monomer composition contains a release agent. When the toner contains a release agent, the releasability of the toner from the fixing roller at the time of toner fixing can be improved. The release agent is not particularly limited, as long as it is one that is generally used as a releasing or softening agent for toners. As the release agent, examples include, but are not limited to, a hydrocarbon wax such as a synthetic wax (e.g., a low-molecular-weight polyolefin wax) and a petroleum wax; an ester wax such as dipentaerythritol ester and carnauba; and a mineral wax such as ozokerite. From the viewpoint of improving the balance between the storage stability and low-temperature fixability of the toner, it is preferable that at least one selected from a hydrocarbon wax or an ester wax is contained, and it is more preferable that at least an ester wax is contained, or both a hydrocarbon wax and an ester wax are contained.

As the hydrocarbon wax, examples include, but are not limited to, a synthetic wax such as a Fischer-Tropsch wax, a low-molecular-weight polyolefin wax (e.g., a polyethylene wax and a polypropylene wax) wax thereof, and a petroleum wax such as a paraffin wax and a microcrystalline wax. Of them, a Fischer-Tropsch wax and a petroleum wax are preferred; a petroleum wax is more preferred; and a paraffin wax is still more preferred.

As the ester wax, a synthetic ester wax obtained by esterifying an alcohol and a carboxylic acid is preferred. As the ester Wax, both a monofunctional ester wax and a polyfunctional ester wax are preferred, and a polyfunctional ester wax obtained by esterifying a polyhydric alcohol and a monocarboxylic acid is more preferred.

For example, as the polyfunctional ester wax, at least one selected from the group consisting of a pentaerythritol ester compound, a glycerin ester compound and a dipentaerythritol ester compound is preferably used. As such a preferable polyfunctional ester wax, examples include, but are not limited to, a pentaerythritol ester compound such as pentaerythritol tetrapalmitate, pentaerythritol tetrabehenate and pentaerythritol tetrastearate; a glycerin ester compound such as hexaglycerin tetrabehenate tetrapalmitate, hexaglycerin octabehenate, pentaglycerin heptabehenate, tetraglycerin hexabehenate, triglycerin pentabehenate, diglycerin tetrabehenate and glycerin tribehenate; and a dipentaerythritol ester compound such as dipentaerythritol hexamyristate and dipentaerythritol hexapalmitate.

As the monofunctional ester wax (monoester wax), examples include, but are not limited to, behenyl palmitate (C₁₅H₃₁—COO—C₂₂H₄₅), behenyl stearate (C₁₇H₃₅—COO—C₂₂H₄₅), behenyl eicosanoate (C₁₉H₃₉—COO—C₂₂H₄₅), behenyl behenate (C₂₁H₄₃—COO—C₂₂H₄₅), eicosyl palmitate (C₁₅H₃₁—COO—C₂₀H₄₁), eicosyl stearate (C₁₇H35—COO—C₂₀H₄₁), eicosyl eicosanoate (C₁₉H₃₉—COO—C₂₀H₄₁), eicosyl behenate (C₂₁H₄₃—COO—C₂₀H₄₁), stearyl stearate (C₁₇H₃₅—COO—C₁₈H₃₇), stearyl eicosanoate (C₁₉H₃₉—COO—C₁₃H₃₇); stearyl behenate (C₂₁H₄₃—COO—C₁₈H₃₇), hexadecyl eicosanoate (C₁₉H₃₉—COO—C₁₆H₃₃) and hexadecyl behenate (C₂₁H₄₃—COO—C₁₆H₃₃). Of them, behenyl stearate, behenyl palmitate and stearyl behenate are preferred.

The weight average molecular weight Mw of the release agent is not particularly limited. It is preferably within a range of from 400 to 3500, and more preferably from 500 to 3000.

In the case of the ester wax, it is also possible to calculate the weight average molecular weight Mw by the following procedure. First, the ester wax is extracted with a solvent; the ester wax is decomposed into an alcohol and a carboxylic acid by hydrolysis; and by carrying out a composition analysis, the molecular weight of the ester wax can be calculated from the structural formula. The weight average molecular weight Mw of the ester wax has the same result as the molecular weight calculated from the structural formula.

The melting point of the release agent is preferably within a range of from 50° C. to 90° C., more preferably within a range of from 60° C. to 85° C., still more preferably within a range of from 65° C. to 80° C., and even more preferably within a range of from 65° C. to 75° C.

The content of the release agent is not particularly limited. From the viewpoint of improving the balance between the storage stability and low-temperature fixability of the toner, the content of the release agent is preferably from 1 part by mass to 30 parts by mass, and more preferably from 5 parts by mass to 20 parts by mass, with respect to 100 parts by mass of the polymerizable monomer. Also, the content of the release agent in the toner is preferably from 1 part by mass to 30 parts by mass, and more preferably from 5 parts by mass to 20 parts by mass, with respect to 100 parts by mass of the binder resin.

The polymerizable monomer composition preferably contains a positively- or negatively-chargeable charge control agent. Accordingly, the chargeability of the toner can be improved.

The charge control agent is not particularly limited, as long as it is one that is generally used as a charge control agent for toners. Among charge control agents, a positively- or negatively-chargeable charge control resin is preferred because it has high compatibility with a polymerizable monomer and can impart stable chargeability (charge stability) to the toner particles.

As the positively-or negatively-chargeable charge control resin, a functional group-containing copolymer can be used. As the positively-chargeable charge control resin, for example, a functional group-containing copolymer that contains a constitutional unit containing a functional group such as an amino group, a quaternary ammonium group and a quaternary ammonium salt-containing group, can be used. Examples of the functional group-containing copolymer include a polyamine resin, quaternary ammonium group-containing copolymer and a quaternary ammonium salt group-containing copolymer. As the negatively-chargeable charge control resin, for example, a functional group-containing copolymer that contains a constitutional unit containing a functional group such as a sulfonic acid group, a sulfonate-containing group, a carboxylic acid group and a carboxylic acid salt-containing group, can be used. Examples of the functional group-containing copolymer include a sulfonic acid group-containing copolymer, a sulfonic acid salt group-containing copolymer, a carboxylic acid group-containing copolymer, and a carboxylic acid salt group-containing copolymer.

The glass transition temperature (Tg) of the charge control resin is preferably from 60° C. to 90° C., more preferably from 65° C. to 85° C., and still more preferably from 70° C. to 80° C. When the glass transition temperature is in the range, the balance between the stability and fixability can be improved.

The weight average molecular weight (Mw) of the charge control resin is preferably from 8, 000 to 28, 000, more preferably from 10,000 to 25,000, and still more preferably from 15,000 to 23,000. When the weight average molecular weight (Mw) is equal to or more than the lower limit value, a decrease in storage stability or printing durability can be suppressed. When the weight average molecular weight (Mw) is equal to or less than the upper limit value, a decrease in fixability can be suppressed. In addition, when the weight average molecular weight (Mw) is in the range, the charge control resin can be appropriately dispersed in the polymerizable monomer composition, and the toner having a charge amount that is stable over time, is easily obtained.

The charge control agent other than the charge control resin may be contained.

As the positively-chargeable charge control agent other than the positively-chargeable charge control resin, examples include a nigrosine dye, a quaternary ammonium salt, a triaminotriphenylmethane compound and an imidazole compound.

As the negatively-chargeable charge control agent other than the negatively-chargeable charge control resin, examples include an azo dye containing a metal such as Cr, Co, Al and Fe, a salicylic acid metal compound and an alkyl salicylic acid metal compound.

The content of the charge control agent is generally from 0.1 parts by mass to 10 parts by mass, preferably from 0.3 parts by mass to 5 parts by mass, and more preferably from 0.6 parts by mass to 2 parts by mass, with respect to 100 parts by mass of the polymerizable monomer. Also, the content of the charge control agent in the toner is generally from 0.1 parts by mass to 10 parts by mass, preferably from 0.3 parts by mass to 5 parts by mass, and more preferably from 0.6 parts by mass to 2 parts by mass, with respect to 100 parts by mass of the binder resin.

When the content of the charge control agent is within the range, excellent printing performance is easily obtained. When the content of the charge control agent is equal to or more than the lower limit value, the occurrence of fog can be suppressed. On the other hand, when the content of the charge control agent is equal to or less than the upper limit value, printing stains can be suppressed.

The polymerizable monomer composition may contain a polar resin. When the colored resin particles contain a polar resin, the storage stability and printing durability of the toner can be improved. The polar resin tends to be unevenly distributed on the surface side of the colored resin particles, and it reinforces the particle surface and suppresses the deterioration of the colored resin particles. Accordingly, the storage stability and printing durability of the toner are improved.

As the polar resin, an acidic group-containing copolymer is preferably used, and an acidic group-containing, acrylate-based copolymer is particularly preferred. As the acidic group-containing, acrylate-based copolymer, for example, a copolymer of a (meth)acrylic ester and (meth)acrylic acid is preferably used. The copolymer of a (meth)acrylic ester and (meth)acrylic acid is a copolymer of at least one kind selected from an acrylic ester or a methacrylic ester and at least one kind selected from acrylic acid or methacrylic acid.

As the copolymer, examples include, but are not limited to, a copolymer of an acrylic ester and acrylic acid, a copolymer of an acrylic ester and methacrylic acid, a copolymer of a methacrylic ester and acrylic acid, a copolymer of a methacrylic ester and methacrylic acid, a copolymer of an acrylic ester, a methacrylic ester and acrylic acid, a copolymer of an acrylic ester, a methacrylic ester and methacrylic acid, and a copolymer of an acrylic ester, a methacrylic ester, acrylic acid and methacrylic acid. Of them, preferred is a copolymer of an acrylic ester, a methacrylic ester and acrylic acid.

As the (meth)acrylic ester, examples include, but are not limited to, methyl (meth) acrylate, ethyl (meth)acrylate, n-propyl (meth)acrylate, isopropyl (meth)acrylate, n-butyl (meth)acrylate, isobutyl (meth)acrylate, sec-butyl (meth)acrylate, tert-butyl (meth)acrylate, n-pentyl (meth)acrylate, sec-pentyl (meth)acrylate, isopentyl (meth)acrylate, neopentyl (meth)acrylate, n-hexyl (meth)acrylate, isohexyl (meth)acrylate, neohexyl (meth)acrylate, sec-hexyl (meth)acrylate and tert-hexyl (meth)acrylate.

As the acrylic ester, ethyl acrylate, n-propyl acrylate, isopropyl acrylate and n-butyl acrylate are preferred, and ethyl acrylate and n-butyl methacrylate are more preferred.

As the methacrylic ester, methyl methacrylate, n-propyl methacrylate, isopropyl methacrylate and n-butyl methacrylate are preferred, and methyl methacrylate is more preferred.

The mass ratio of the monomer units constituting the acrylate-based copolymer is preferably adjusted so that the below-described acid value and glass transition temperature Tg are satisfied.

Of 100% by mass of all the monomer units constituting the acrylate-based copolymer, the content of the (meth)acrylic acid unit is, as the lower limit thereof, preferably 0.05% by mass or more, more preferably 0.18 by mass or more, and still more preferably 0.3% by mass or more. On the other hand, the content is, as the upper limit thereof, preferably 1.0% by mass or less, more preferably 0.6% by mass or less, and still more preferably 0.5% by mass or less.

Of 100% by mass of all the monomer units constituting the acrylate-based copolymer, the content of the (meth) acrylic ester unit is, as the lower limit thereof, preferably 99.0% by mass or more, more preferably 99.4% by mass or more, and still more preferably 99.5% by mass or more. On the other hand, the content is, as the upper limit thereof, preferably 99.95% by mass or less, more preferably 99.9% by mass or less, and still more preferably 99.7% by mass or less.

To the extent that does not impair the object of the present disclosure, the acrylate-based copolymer may contain another monomer unit different from the (meth)acrylic acid unit and the (meth)acrylic acid unit. As the another monomer, examples include, but are not limited to, the styrene derivative, nitrile compound and amide compound exemplified above as the monovinyl monomer constituting the binder resin.

In the acrylate-based copolymer, the content of the another monomer unit is preferably 10% by mass or less, more preferably 2% by mass or less, and most preferably 0% by mass, with respect to 100% by mass of the (meth)acrylic ester unit.

The acid value of the polar resin is not particularly limited. The acid value of the polar resin is, as the lower limit thereof, preferably 0.5 mgKOH/g or more, more preferably 1.0 mgKOH/g or more, and still more preferably 2.0 mgKOH/g or more. On the other hand, the acid value is, as the upper limit thereof, preferably 5.0 mgKOH/g or less, more preferably 4.0 mgKOH/g or less, and still more preferably 3.0 mgKOH/g. When the acid value of the polar resin is in the range, the toner excellent in low-temperature fixability, storage stability and printing durability is easily obtained.

In the present disclosure, the acid value of the resin is measured according to JIS K 0070.

The weight average molecular weight (Mw) of the polar resin is not particularly limited. The weight average molecular weight of the polar resin is, as the lower limit thereof, preferably 6,000 or more, more preferably 7,000 or more, and still more preferably 9,000 or more. On the other hand, the weight average molecular weight is, as the upper limit thereof, preferably 50,000 or less, more preferably 45, 000 or less, and still more preferably 40,000 or less.

When the weight average molecular weight (Mw) of the polar resin is in the range, the toner excellent in low-temperature fixability, storage stability and printing durability is easily obtained.

The glass transition temperature Tg of the polar resin is not particularly limited. The glass transition temperature of the polar resin is, as the lower limit thereof, preferably 60° C. or more, more preferably 65° C. or more, and still more preferably 70° C. or more, On the other hand, the glass transition temperature is, as the upper limit thereof, preferably 85° C. or less, more preferably 80° C. or less, and still more preferably 77° C. or less.

When the glass transition temperature Tg of the polar resin is in the range, the toner excellent in low-temperature fixability, storage stability and printing durability is easily obtained.

The grass transition temperature Tg can be obtained according to ASTM D3418-82.

The content of the polar resin is, as the lower limit thereof, preferably 0.2 parts by mass or more, more preferably 0.5 parts by mass or more, and still more preferably 1 part by mass or more, with respect to 100 parts by mass of the binder resin. On the other hand, the content is, as the upper limit thereof, preferably 5 parts by mass or less, more preferably 3 parts by mass or less, still more preferably 2 parts by mass or less, and even more preferably 1.5 parts by mass or less, with respect to 100 parts by mass of the binder resin.

When the content of the polar resin is equal to or more than the lower limit value, a decrease in printing durability is suppressed. When the content of the polar resin is equal to or less than the upper limit value, the charge amount of the toner easily becomes appropriate. Especially, a decrease in the charge amount of the toner is suppressed; moreover, a decrease in production stability and a decrease in low-temperature fixability are suppressed.

A commercially-available product can be used as the polar resin, or the polar resin can be produced by a known polymerization method such as solution polymerization, aqueous solution polymerization, ionic polymerization, high-temperature and high-pressure polymerization and suspension polymerization.

A typical example of the method for producing the polar resin is as described below. Note that the polar resin production method is not limited to the following typical example.

First, a solvent is put in a reaction container as appropriate. After the atmosphere inside the reaction container is replaced by an inert atmosphere, the temperature of the inside of the reaction container is increased, and a raw material monomer is put in the reaction container. At this time, a polymerization initiator is preferably added in combination with the raw material monomer. It is also preferable to put the mixture of the raw material monomer and the polymerization initiator in a dropwise manner in the reaction container. Next, the temperature of the contents of the reaction container is increased to a temperature at which a polymerization reaction is developed, thereby initiating polymerization. After the polymerization is completed, the solvent is removed by distillation as appropriate, thereby obtaining the desired polar resin.

It is preferable that in the polymerization of the polymerizable monomer, a molecular weight modifier is used as another additive in the polymerizable monomer composition.

The molecular weight modifier is not particularly limited, as long as it is one that is generally used as a molecular weight modifier for toners. As the molecular weight modifier, examples include, but are not limited to, mercaptans such as t-dodecyl mercaptan, n-dodecyl mercaptan, n-octyl mercaptan and 2,2,4,6,6-pentamethylheptane-4-thiol; and thiuram disulfides such as tetramethyl thiuram disulfide, tetraethyl thiuram disulfide, tetrabutyl thiuram disulfide, N,N′-dimethyl-N, N′-diphenyl thiuram disulfide and N,N′-dioctadecyl-N,N′-diisopropyl thiuram disulfide. These molecular weight modifiers may be used alone or in combination of two or more thereof.

The content of the molecular weight modifier is generally from 0.01 parts by mass to 10 parts by mass, and preferably from 0.1 parts by mass to 5 parts by mass, with respect to 100 parts by mass of the monovinyl monomer.

### (2) Suspension Step (Droplet Forming Step) to Obtain Suspension

Then, the polymerizable monomer composition is dispersed in an aqueous medium containing a dispersion stabilizer, and after adding a polymerization initiator, droplet formation of the polymerizable monomer composition is performed. The polymerization initiator may be added before the droplet formation after the polymerizable monomer composition is dispersed in an aqueous medium, as described above. However, the polymerization initiator may be added to the polymerizable monomer composition before being dispersed in an aqueous medium.

Examples of the polymerization initiator include, but are not limited to, persulfates such as potassium persulfate and ammonium persulfate; azo compounds such as 4,4′-azobis (4-cyanovaleric acid), 2,2′-azobis(2-methyl-N-(2-hydroxyethyl)propionamide), 2,2′-azobis(2-amidinopropane)dihydrochloride, 2,2′-azobis(2,4-dimethylvaleronitrile) and 2,2′-azobisisobutyronitrile; and organic peroxides such as di-t-butylperoxide, benzoylperoxide, t-butylperoxy-2-ethylhexanoate, t-butylperoxy-2-ethylbutanoate, t-hexylperoxy-2-ethylbutanoate, t-butylperoxy diethylacetate, diisopropylperoxydicarbonate, di-t-butylperoxyisophthalate and t-butylperoxyisobutyrate. Among them, an organic peroxide is preferably used because the residual polymerizable monomer can be reduced, and the printing durability of the toner becomes excellent. From the point of view that the initiator efficiency is high and the residual polymerizable monomer can be reduced, among the organic peroxides, peroxy esters are preferred, and non-aromatic peroxy esters, that is, peroxy esters having no aromatic ring, are more preferred.

These polymerization initiators may be used alone or in combination of two or more thereof.

The amount of the polymerization initiator to be added, which is used for the polymerization of the polymerizable monomer composition, is preferably from 0.1 parts by mass to 20 parts by mass, more preferably from 0.3 parts by mass to 15 parts by mass, and still more preferably from 1 part by mass to 10 parts by mass, with respect to 100 parts by mass of the monovinyl monomer.

In the present disclosure, the aqueous medium is a medium containing water as a main component, and it is typically water.

In the present disclosure, it is preferable that a dispersion stabilizer is contained in the aqueous medium. As the dispersion stabilizer, examples include the following inorganic and organic compounds: inorganic compounds including sulfates such as barium sulfate and calcium sulfate, carbonates such as barium carbonate, calcium carbonate and magnesium carbonate, phosphates such as calcium phosphate, metal oxides such as aluminum oxide and titanium oxide, metal hydroxides such as aluminum hydroxide, magnesium hydroxide and iron (II) hydroxide, and silicon dioxide, and organic compounds including water-soluble polymers such as polyvinyl alcohol, methyl cellulose and gelatin; anionic surfactants, nonionic surfactants, and ampholytic surfactants. These dispersion stabilizers may be used alone or in combination of two or more thereof.

Among the dispersion stabilizers, the inorganic compound, especially a colloid of the sparingly water-soluble metal hydroxide, is preferred. The use of the inorganic compounds, particularly the use of the colloid of the sparingly water-soluble metal hydroxide, can narrow the particle size distribution of the colored resin particles and can reduce the amount of the dispersion stabilizer remaining after washing. Accordingly, the toner thus obtained becomes capable of reproducing clear images and is excellent in environmental stability,

The sparingly water-soluble metal hydroxide colloid can be prepared by, for example, reacting a water-soluble polyvalent metal salt (excluding an alkaline earth metal hydroxide salt) and at least one selected from an alkali metal hydroxide salt or an alkaline earth metal hydroxide salt in the aqueous medium.

As the alkali metal hydroxide salt, examples include, but are not limited to, lithium hydroxide, sodium hydroxide and potassium hydroxide. As the alkaline earth metal hydroxide salt, examples include, but are not limited to, barium hydroxide and calcium hydroxide.

The water-soluble polyvalent metal salt may be a water-soluble polyvalent metal salt other than compounds corresponding to alkaline earth metal hydroxide salts. As the water-soluble polyvalent metal salt, examples include, but are not limited to, a magnesium metal salt such as magnesium chloride, magnesium phosphate and magnesium sulfate; a calcium metal salt such as calcium chloride, calcium nitrate, calcium acetate and calcium sulfate; an aluminum metal salt such as aluminum chloride and aluminum sulfate; a barium salt such as barium chloride, barium nitrate and barium acetate; and a zinc salt such as zinc chloride, zinc nitrate and zinc acetate. Among them, a magnesium metal salt, a calcium metal salt and an aluminum metal salt are preferred; a magnesium metal salt is more preferred; and magnesium chloride is particularly preferred.

As the method for reacting the water-soluble polyvalent metal salt and at least one selected from the alkali metal hydroxide salt or the alkaline earth metal hydroxide salt in the aqueous medium, examples include, but are not limited to, a method in which an aqueous solution of the water-soluble polyvalent metal salt and an aqueous solution of at least one selected from the alkali metal hydroxide salt or the alkaline earth metal hydroxide salt are mixed together.

Also, colloidal silica may be used as the colloidal dispersion containing the sparingly water-soluble inorganic dispersion stabilizer colloidal particles.

The content of the dispersion stabilizer is appropriately adjusted so that the toner having the desired particle diameter is obtained, and it is not particularly limited. With respect to 100 parts by mass of the polymerizable monomer in the polymerizable monomer composition, the content of the dispersion stabilizer is preferably from 0.5 parts by mass to 10 parts by mass, and more preferably from 1.0 part by mass to 8.0 parts by mass. When the content of the dispersion stabilizer is equal to or more than the lower limit value, the droplets of the polymerizable monomer composition can be sufficiently dispersed in the suspension so that they do not join together. On the other hand, when the content of the dispersion stabilizer is equal to or less than the upper limit value, an increase in the viscosity of the suspension can be prevented during the droplet formation, and a failure such as clogging of a granulator with the suspension can be avoided.

Also, the content of the dispersion stabilizer is generally from 1 part by mass to 15 parts by mass, and preferably from 1 part by mass to 8 parts by mass, with respect to 100 parts by mass of the aqueous medium.

The polymerizable monomer composition is poured into the aqueous medium containing the dispersion stabilizer, and the mixture is strongly stirred, thereby obtaining a suspension in which the polymerizable monomer composition droplets are dispersed in the aqueous medium.

The strong stirring for forming the polymerizable monomer composition droplets, is not particularly limited. For example, it can be carried out by any of the following dispersers: a horizontal or vertical in-line disperser such as MILDER (product name, manufactured by Pacific Machinery & Engineering Co., Ltd.), CAVITRON (product name, manufactured by EUROTEC, Ltd.) and an in-line disperser manufactured by IKA (e.g., DISPAX-REACTOR (registered trademark) DRS (product name)), and an emulsifying disperser such as HOMOMIXER MARK II series manufactured by PRIMIX Corporation.

In the suspension step, the stirring time is appropriately adjusted depending on the amount of the polymerizable monomer composition, and it is not particularly limited.

By adjusting the conditions of the stirring that is carried out in the suspension step, the particle diameter of the toner particles, that is, the equivalent circular area diameter thereof can be adjusted. The conditions of the stirring that is carried out in the suspension step, have almost no influence on the compactness of the toner and the maximum inscribed circle diameter/equivalent circular area diameter ratio thereof.

### (3) Polymerization Step

After the polymerizable monomer composition is formed into droplets as described above in (2), the polymerizable monomer composition is subjected to a polymerization reaction in the presence of a polymerization initiator to form colored resin particles. In other words, a suspension in which droplets of the polymerizable monomer composition are dispersed, is heated to develop the polymerization reaction of the polymerizable monomer, thereby obtaining an aqueous dispersion of colored resin particles.

In the present disclosure, from the viewpoint of obtaining the toner having the desired compactness and the desired maximum inscribed circle diameter/equivalent circular area diameter ratio, it is preferable that before the temperature of the suspension is increased to the polymerization reaction temperature, the suspension is stirred under the following conditions: the tip speed of the stirring blades is from 0.8 m/s to 2.5 m/s, and the stirring time is from 5 minutes to 10 hours. It is preferable to appropriately adjust the stirring conditions so that the toner having the desired compactness and the desired maximum inscribed circle diameter/equivalent circular area diameter ratio is obtained, and the stirring conditions are not particularly limited. The lower limit of the tip speed of the stirring blades is more preferably 0.9 m/s or more, and the upper limit thereof is more preferably 2.0 m/s or less, still more preferably 1.8 m/s or less, and even more preferably 1.6 m/s or less. The upper limit of the stirring time is more preferably 8 hours or less, and still more preferably 6 hours or less.

The tip speed of the stirring blades can be obtained by the following formula.

Tip speed (m/s) of the stirring blades=Circular constant×Diameter (m) of each stirring blade×Rotational speed (s−1)

In this formula, the diameter of the stirring blade is a value obtained by doubling the maximum value of the linear distance between the central axis of the shaft and the tip of the stirring blade when observing the stirring blade from the central axis direction of the shaft.

In the stirring of the suspension before initiating the polymerization reaction, the temperature of the suspension is not particularly limited. From the viewpoint of preventing the precipitation of the release agent dissolved in the droplets and suppressing the development of the polymerization reaction, the suspension temperature is preferably from 35° C. to 55° C., and more preferably from 40° C. to 50° C.

It is estimated that, by stirring the suspension in the above conditions before the initiation of the polymerization reaction and keep stirring the suspension during the polymerization reaction, collision of the droplets can be suppressed; the shear force applied to the droplets can be decreased; and the toner having the desired compactness and the desired maximum inscribed circle diameter/equivalent circular area diameter ratio can be obtained, accordingly.

The heating temperature when the suspension is subjected to the polymerization reaction, is not particularly limited. From the viewpoint of quickly developing the polymerization reaction, the heating temperature is preferably 60° C. or more, and more preferably 70° C. or more. On the other hand, from the viewpoint of suppressing the rapid development of the polymerization reaction and stabilizing the quality of the obtained toner, the heating temperature is preferably 95° C. or less.

The heating time is preferably from 1 hour to 20 hours, and more preferably from 2 hours to 15 hours.

From the viewpoint of obtaining the toner having the desired compactness and the desired maximum inscribed circle diameter/equivalent circular area diameter ratio, during the polymerization reaction, the suspension is preferably stirred under the condition where the tip speed of the stirring blades is from 0.8 m/s to 2.5 m/s.

It is preferable to appropriately adjust the stirring conditions so that the toner having the desired compactness and the desired maximum inscribed circle diameter/equivalent circular area diameter ratio is obtained, and the stirring conditions are not particularly limited. The lower limit of the tip speed of the stirring blades is more preferably 0.9 m/s or more, and the upper limit thereof is more preferably 2.0 m/s or less, still more preferably 1.8 m/s or less, and even more preferably 1.6 m/s or less. From the viewpoint of obtaining the toner having the desired compactness and the desired maximum inscribed circle diameter/equivalent circular area diameter ratio, during the polymerization reaction of the polymerizable monomer composition, the dispersion is preferably stirred at the same tip speed of the stirring blades as the stirring of the suspension before initiating the polymerization reaction.

In the present disclosure, the colorant resin particles obtained by the polymerization step, on which an external additive is added, may be used as the toner. It is preferable to use the colored resin particles obtained by the polymerization step as the core layer of colored resin particles of a so-called core-shell type (or also referred to as “capsule type”). The core-shell type colored resin particles have a structure in which the outside of the core layer is coated with a shell layer formed of a material different from the core layer. By coating the core layer made of a material having a low softening point with a material having a softening point higher than that, the low-temperature fixability and storage stability of the toner can be improved in a well-balanced manner.

The method for producing the core-shell type colored resin particles by using the colored resin particles obtained by the polymerization step, is not particularly limited. The core-shell type colored resin particles can be produced by any conventional method. The in situ polymerization method and the phase separation method are preferable from the viewpoint of production efficiency.

A method for producing the core-shell type colored resin particles by the in situ polymerization method will be described below.

A polymerizable monomer for forming a shell layer (a polymerizable monomer for shell) and a polymerization initiator are added to the aqueous dispersion in which the colorant resin particles are dispersed, and the mixture is polymerized, thereby obtaining the core-shell type colored resin particles.

As the polymerizable monomer for shell, the same polymerizable monomers as the polymerizable monomers described above can be used. Among them, those that can be a polymer having a Tg of more than 80° C., such as styrene, acrylonitrile and methyl methacrylate, are preferably used alone or in combination of two or more thereof.

As the polymerization initiator used for the polymerization of the polymerizable monomer for shell, examples include, but are not limited to, water-soluble polymerization initiators including such metal persulfates as potassium persulfate and ammonium persulfate, and azo-type initiators such as 2, 2′-azobis(2-methyl-N-(2-hydroxyethyl)propionamide) and 2, 2′-azobis(2-methyl-N-(1, 1-bis(hydroxymethyl)-2-hydroxyethyl)propionamide). These polymerization initiators may be used alone or in combination of two or more thereof.

The content of the polymerization initiator is preferably from 0.1 parts by mass to 30 parts by mass, and more preferably from 1 part by mass to 20 parts by mass, with respect to 100 parts by mass of the polymerizable monomer for shell.

The polymerization temperature of the shell layer is not particularly limited. From the viewpoint of quickly developing the polymerization reaction, the polymerization temperature of the shell layer is preferably 60° C. or more, and more preferably 70° C. or more. On the other hand, from the viewpoint of suppressing the volatilizing of the polymerizable monomer for shell, the polymerization temperature of the shell layer is preferably 95° C. or less.

The polymerization reaction time of the shell layer is preferably from 1 hour to 20 hours, and more preferably from 2 hours to 15 hours.

From the viewpoint of attaching uniformly the polymerizable monomer for shell to the core layer, during the polymerization reaction of the shell layer, the dispersion is preferably stirred under the condition where the tip speed of the stirring blades is from 0.8 m/s to 2.5 m/s. The polymerization conditions of the shell layer have almost no influence on the compactness of the toner and the maximum inscribed circle diameter/equivalent circular area diameter ratio thereof.

### (4) Washing, Filtrating, Dehydrating and Drying Step

It is preferable that, after completion of the polymerization, the operation of washing, filtration, dehydration and drying is repeatedly preformed several times as necessary on the aqueous dispersion of the colored resin particles obtained by the polymerization, according to a conventional method.

As the method of the washing, when an inorganic compound is used as the dispersion stabilizer, it is preferable to dissolve the dispersion stabilizer in water, by addition of an acid or an alkali to an aqueous dispersion of the colored resin particles, and then remove the dissolved dispersion stabilizer from the water. When a colloid of a hardly water-soluble inorganic hydroxide is used as the dispersion stabilizer, it is preferable to add an acid to adjust the pH of the colored resin particle aqueous dispersion to 6.5 or less. As the acid to be added, inorganic acids such as sulfuric acid, hydrochloric acid and nitric acid, and organic acids such as formic acid and acetic acid can be used, and sulfuric acid is particularly preferred because of the high removal efficiency and small burden on the production facilities.

The dehydration and filtration may be carried out by various known methods, without any particular limitation. For example, a centrifugal filtration method, a vacuum filtration method and a pressure filtration method may be used. Also, the drying method is not particularly limited, and various kinds of methods may be used.

In the present disclosure, the binder resin contained in the colored resin particles is typically a polymer of the polymerizable monomer. A small amount of polyester-based resin, epoxy-based resin or the like, which are conventionally widely used as a binder resin in toners, or an unreacted polymerizable monomer may be contained. The content of the polyester-based resin contained in 100 parts by mass of the binder resin is preferably 5 parts by mass or less, more preferably 1 part by mass or less, and still more preferably 0.1 parts by mass or less. It is particularly preferable that the binder resin does not contain a polyester-based resin. When the content of the polyester-based resin is equal to or lower than the above upper limit value, the environmental stability of the toner can be improved, and in particular, a change in the charging of the toner due to a change in humidity can be suppressed.

In addition, when the binder resin contains a resin other than the polymer of the polymerizable monomer, the content of the polymer of the polymerizable monomer in 100 parts by mass of the binder resin is preferably 95 parts by mass or more, more preferably 97 parts by mass or more, and still more preferably 99 parts by mass or more.

### <External Addition Treatment Method>

The toner of the present disclosure can be a one-component toner (developer) by performing an external addition treatment, in which the external additive is mixed and stirred with the colored resin particles, to add the external additive on the surface of the colored resin particles, thereby obtaining the one-component toner (developer). The one-component toner may be mixed and stirred with carrier particles to obtain a two-component developer.

As the method of the external addition treatment for adding the external additive on the surface of the colored resin particles, a known external addition treatment method can be employed and is not particularly limited. For example, the external addition treatment can be performed by mixing and stirring the colored resin particles and the external additive, using a mixer capable of mixing and stirring, such as HENSCHEL MIXER (product name, manufactured by: Mitsui Mining Co., Ltd.), FM MIXER (product name, manufactured by: NIPPON COKE & ENGINEERING CO., LTD.), SUPER MIXER (product name, manufactured by: KAWATA Manufacturing Co., Ltd.), Q MIXER (product name, manufactured by: NIPPON & COKE ENGINEERING CO., LTD.), MECHANOFUSION SYSTEM (product name, manufactured by: Hosokawa Micron Corporation) and MECHANOMILL (product name, manufactured by: Okada Seiko Co., Ltd.)

The peripheral speed of the stirring blades in the external addition treatment is not particularly limited, and it is preferably from 30 m/s to 50 m/s. The external addition treatment time is not particularly limited, and it is preferably from 1 minute to 15 minutes.

The toner of the present disclosure preferably contains one kind of the below-described inorganic fine particles A to C as the external additive, that is, it preferably contains inorganic fine particles having a number average primary particle diameter of from 6 nm to 100 nm. Also, the toner of the present disclosure more preferably contains two kinds of them, and still more preferably contains all of the three kinds. By appropriately controlling the particle diameter and amount of the inorganic fine particles A to C to be added, the low-temperature fixability and storage stability of the toner can be improved in a well-balanced manner.

The inorganic fine particles A are inorganic fine particles having a number average primary particle diameter of from 36 nm to 100 nm. When the number average primary particle diameter of the inorganic fine particles A is less than 36 nm, an adverse effect on printing performance (e.g., fog) may occur due to a decrease in spacer effect. On the other hand, when the number average primary particle diameter of the inorganic fine particles A is more than 100 nm, an adverse effect on printing performance may occur, since the inorganic fine particles A are likely to be released from the surface of the toner particles, so that the function of the inorganic fine particles A as the external additive decreases.

The number average primary particle diameter of the inorganic fine particles A is, as the lower limit thereof, more preferably 40 nm or more, and still more preferably from 45 nm. On the other hand, the number average primary particle diameter is, as the upper limit thereof, more preferably 80 nm or less, and still more preferably 70 nm or less.

Also, the inorganic fine particles A are preferably hydrophobized particles.

In the present disclosure, for example, a silane coupling agent, silicone oil, fatty acid, fatty acid metal salt or the like can be used as the hydrophobizing agent. Among them, a silane coupling agent and silicone oil are preferred.

The content of the inorganic fine particles A is, as the lower limit thereof, preferably 0.30 parts by mass or more, more preferably 0.50 parts by mass or more, and still more preferably 1.00 part by mass or more, with respect to 100 parts by mass of the colored resin particles. On the other hand, the content is, as the upper limit thereof, preferably 3.00 parts by mass or less, more preferably 2.50 parts by mass or less, and still more preferably 2.00 parts by mass or less, with respect to 100 parts by mass of the colored resin particles.

When the content of the inorganic fine particles A is equal to or more than the lower limit value, the inorganic fine particles A can sufficiently function as the external additive. Accordingly, a deterioration in printing performance or storage stability is suppressed. On the other hand, when the content of the inorganic fine particles A is equal to or less than the upper limit value, the release of the inorganic fine particles A from the surface of the toner particles is suppressed. Accordingly, a deterioration in printing performance is suppressed.

The inorganic fine particles B are inorganic fine particles having a number average primary particle diameter of from 15 nm to 35 nm. When the number average primary particle diameter of the inorganic fine particles B is less than 15 nm, the following problems may occur: since the inorganic fine particles B easily penetrate from the surface of the colored resin particles to the inside of the colored resin particles, sufficient flowability cannot be to imparted the toner particles, and an adverse effect may be imposed on printing performance, accordingly. On the other hand, when the number average primary particle diameter of the inorganic fine particles B is more than 35 nm, the following problems may occur: since the proportion of the inorganic fine particles B to the surface of the toner particles (the surface coverage) decreases, sufficient flowability cannot be to imparted the toner particles.

The number average primary particle diameter of the inorganic fine particles B is, as the lower limit thereof, more preferably 17 nm or more, and still more preferably 20 nm or more. On the other hand, the number average primary particle diameter is, as the upper limit thereof, more preferably 30 nm or less, and still more preferably 25 nm or less. Also, the inorganic fine particles B are preferably hydrophobized particles.

The content of the inorganic fine particles B is, as the lower limit thereof, preferably 0.10 parts by mass or more, more preferably 0.30 parts by mass or more, and still more preferably 0.50 parts by mass or more, with respect to 100 parts by mass of the colored resin particles. On the other hand, the content is, as the upper limit thereof, preferably 2.00 parts by mass or less, more preferably 1.50 parts by mass or less, and still more preferably 1.00 part by mass or less, with respect to 100 parts by mass of the colored resin particles.

When the content of the inorganic fine particles B is equal to or more than the lower limit value, the inorganic fine particles B can sufficiently function as the external additive. Accordingly, a decrease in flowability is suppressed, and a deterioration in storage stability or durability is suppressed. On the other hand, when the content of the inorganic fine particles B is equal to or less than the upper limit value, the release of the inorganic fine particles B from the surface of the toner particles is suppressed. Accordingly, a deterioration in charge property is suppressed, thereby suppressing the occurrence of fog.

The inorganic fine particles C are inorganic fine particles having a number average primary particle diameter of from 6 nm to 14 nm. When the number average primary particle diameter of the inorganic fine particles C is less than 6 nm, the following problems may occur: since the inorganic fine particles C easily penetrate from the surface of the colored resin particles to the inside of the colored resin particles, sufficient flowability cannot be imparted to the toner particles, and an adverse effect may be imposed on printing performance, accordingly. On the other hand, when the number average primary particle diameter of the inorganic fine particles C is more than 14 nm, the following problems may occur: since the proportion of the inorganic fine particles C to the surface of the toner particles (the surface coverage) decreases, sufficient flowability cannot be imparted to the toner particles.

The number average primary particle diameter of the inorganic fine particles C is, as the lower limit thereof, more preferably 6.5 nm or more, and still more preferably 7.0 nm or more. On the other hand, the number average primary particle diameter is, as the upper limit thereof, more preferably 12 nm or less, and still more preferably 10 nm or less.

Also, the inorganic fine particles C are preferably hydrophobized particles.

The content of the inorganic fine particles C is, as the lower limit thereof, preferably 0.10 parts by mass or more, more preferably 0.15 parts by mass or more, and still more preferably 0.20 parts by mass or more, with respect to 100 parts by mass of the colored resin particles. On the other hand, the content is, as the upper limit thereof, preferably 1.50 parts by mass or less, more preferably 1.00 part by mass or less, still more preferably 0.80 parts by mass or less, and even more preferably 0.60 parts by mass or less, with respect to 100 parts by mass of the colored resin particles.

When the content of the inorganic fine particles C is equal to or more than the lower limit value, the inorganic fine particles C can sufficiently function as the external additive. Accordingly, a decrease in flowability is suppressed, and a deterioration in storage stability is suppressed. On the other hand, when the content of the inorganic fine particles C is equal to or less than the upper limit value, the release of the inorganic fine particles C from the surface of the toner particles is suppressed. Accordingly, a deterioration in charge property is suppressed, thereby suppressing the occurrence of fog.

As the inorganic fine particles A to C, examples include, but are not limited to, silica, titanium oxide, aluminum oxide, zinc oxide, tin oxide, calcium carbonate, calcium phosphate, cerium oxide, barium titanate and strontium titanate. The inorganic fine particles A to C may be composed of different materials. However, it is preferable that they are composed of the same material. It is preferable that all of the inorganic fine particles A to C contain at least one selected from silica or titanium oxide, and it is more preferable that all of the inorganic fine particles A to Care silica fine particles.

Various kinds of commercially-available silica fine particles can be used as the inorganic fine particles A, such as VPNA50H (product name, manufactured by: Nippon Aerosil Co., Ltd., number average primary particle diameter: 40 nm) and H05TA (product name, manufactured by: Clariant Corporation, number average primary particle diameter: 50 nm).

Various kinds of commercially-available silica fine particles can be used as the inorganic fine particles B, such as NA50Y (product name, manufactured by: Nippon Aerosil Co., Ltd., number average primary particle diameter: 35 nm), MSP-012 (product name, manufactured by: Tayca Corporation, number average primary particle diameter: 16 nm) and TG-7120 (product name, manufactured by: Cabot Corporation, number average primary particle diameter: 20 nm).

Various kinds of commercially-available silica fine particles can be used as the inorganic fine particles C, such as HDK2150 (product name, manufactured by: Clariant Corporation, number average primary particle diameter: 12 nm), R504 (product name, manufactured by: Nippon Aerosil Co., Ltd., number average primary particle diameter: 12 nm), RA200HS (product name, manufactured by: Nippon Aerosil Co., Ltd., number average primary particle diameter: 12 nm), MSP-013 (product name, manufactured by: Tayca Corporation, number average primary particle diameter: 12 nm) and TG-820F (product name, manufactured by: Cabot Corporation, number average primary particle diameter: 7 nm).

The content of the inorganic fine particles having a number average primary particle diameter of from 6 nm to 100 nm which are contained as the external additive, that is, the total content of the inorganic fine particles A to C is not particularly limited. With respect to 100 parts by mass of the colored resin particles, the total content is, as the lower limit thereof, preferably 0.50 parts by mass or more, more preferably 1.00 part by mass or more, and still more preferably 1.70 parts by mass or more. On the other hand, the total content is, as the upper limit thereof, preferably 6.50 parts by mass or less, more preferably 5.00 parts by mass or less, and still more preferably 4.00 parts by mass or less.

Also, the toner of the present disclosure preferably contains organic fine particles as the external additive. As the organic fine particles, the toner preferably contains organic fine particles D having a number average primary particle diameter of 1.0 μm or less. When the toner contains the organic fine particles D as the external additive, aggregation of the toner is suppressed, and toner leakage can be suppressed, accordingly. In addition, filming on a photoconductor is less likely to occur, and the toner particles are provided with stable charge property over time, so that such a toner is obtained, that a deterioration in image quality (e.g., fog) is less likely to occur even after continuous printing is carried out on many sheets.

From the point of view that these effects can be easily exerted by the organic fine particles D, the number average primary particle diameter of the organic fine particles D is, as the lower limit thereof, preferably 0.1 μm or more, more preferably 0.3 μm or more, still more preferably 0.4 μm or more, and particularly preferably 0.5 μm or more. On the other hand, the number average primary particle diameter is, as the upper limit thereof, more preferably 0.9 μm or less, and still more preferably 0.8 μm or less.

The content of the organic fine particles D is, as the lower limit thereof, preferably 0.05 parts by mass or more, more preferably 0.07 parts by mass or more, and still more preferably 0.10 parts by mass or more, with respect to 100 parts by mass of the colored resin particles. On the other hand, the content is, as the upper limit thereof, preferably 1.0 parts by mass or less, more preferably 0.50 parts by mass or less, still more preferably 0.30 parts by mass or less, and even more preferably 0.20 parts by mass or less, with respect to 100 parts by mass of the colored resin particles.

When the content of the organic fine particles D is equal to or more than the lower limit value, the organic fine particles D can sufficiently function as the external additive, and the above-described effects by the organic fine particles are easily obtained, accordingly. On the other hand, when the content of the organic fine particles D is equal to or less than the upper limit value, a deterioration in the fixability of the toner, which is due to the large external additive amount, can be suppressed. In addition, when the content of the organic fine particles D is equal to or less than the upper limit value, the release of the organic fine particles D from the surface of the toner particles is suppressed, and a decrease in flowability is suppressed, accordingly.

As the organic fine particles D, examples include, but are not limited to, fatty acid metal salt particles such as zinc stearate and magnesium stearate, organosilicon polymer particles as such silicone resin particles, methacrylate polymer particles, acrylate polymer particles, styrene-methacrylate copolymer particles, styrene-acrylate copolymer particles, core-shell particles in which the core is made of a styrene polymer and the shell is made of a methacrylate polymer, and melamine resin particles. As the organic fine particles D, fatty acid metal salt particles are preferably used.

The fatty acid (R—COOH) that serves to derive the fatty acid moiety (R—COO—) of the fatty acid metal salt particles, may be a monocarboxylic acid containing only one carboxyl group (—COOH), and it is preferably a monocarboxylic acid having a chain structure, more preferably a saturated monocarboxylic acid having a chain structure, and still more preferably a linear saturated monocarboxylic acid.

Also, the fatty acid moiety (R—COO₋) of the fatty acid metal salt particles is preferably one derived from a higher fatty acid in which the alkyl group (R—) contains many carbon atoms. The number of the carbon atoms of the alkyl group in the fatty acid moiety is not particularly limited. It is preferably from 12 to 24, more preferably from 14 to 22, and still more preferably from 16 to 20.

As the higher fatty acid that is preferably used as a raw material for the fatty acid metal salt particles, examples include, but are not limited to, lauric acid (CH₃(CH₂)₁₀COOH), tridecanoic acid (CH₃(CH₂)₁₁COOH), myristic acid (CH₃(CH₂)₁₂COOH), pentadecanoic acid (CH₃(CH₂)₁₃COOH), palmitic acid (CH₃(CH₂)₁₄COOH), heptadecanoic acid (CH₃(CH₂)₁₅COOH), stearic acid (CH₃(CH₂)₁₆COOH), arachidic acid (CH₃(CH₂)₁₈COOH), behenic acid (CH₃(CH₂)₂₀COOH) and lignoceric acid (CH₃(CH₂)₂₂COOH). Of them, stearic acid and behenic acid are preferred, and stearic acid is more preferred.

These fatty acids that are preferably used as a raw material for the fatty acid metal salt particles, may be used alone or in combination of two or more kinds. From the viewpoint of obtaining a uniform toner property, any one kind of the fatty acids is preferably used alone.

The metal contained in the fatty acid metal salt particles may be an alkaline metal, an alkaline-earth metal or a metal element of the Group 12 of the periodic table, such as Li, Na, K, Rb, Cs, Be, Mg, Ca, Sr, Ba and Zn. Of them, an alkaline-earth metal or a metal element of the Group 12 of the periodic table is preferred; at least one selected from Mg or Zn is more preferred; and Zn is still more preferred.

As the fatty acid metal salt particles, various kinds of Commercially-available products can be used. As the products, examples include, but are not limited to, SPZ-100F (product name, zinc stearate particles manufactured by: Sakai Chemical Industry Co., Ltd., number average primary particle diameter: 0.5 μm) and SPX-100F (product name, magnesium stearate particles manufactured by: Sakai Chemical Industry Co., Ltd., number average primary particle diameter: 0.72 μm).

The number average primary particle diameter of the external additive particles used in the toner of the present disclosure is measured as follows, for example. First, about 0.1 g of a measurement sample is weighed out and put in a beaker. Next, as a dispersant, 0.1 mL of an alkylbenzene sulphonic acid aqueous solution (product name: DRIWEL, manufactured by: Fujifilm Corporation) is added thereto. In addition, 10 mL to 30 mL of a diluent (product name: ISOTON II, manufactured by: Beckman Coulter, Inc.) is put in the beaker. The mixture is dispersed for 3 minutes with a 20 W (watt) ultrasonic disperser. Then, the number average primary particle diameter is measured with a particle size analyzer (product name: MULTISIZER, manufactured by: Beckman Coulter, Inc.) under the following conditions: aperture diameter: 100 μm, medium: ISOTON II, and the number of measured particles: 100,000 particles.

### 3. Performance of the Toner

The toner of the present disclosure hardly causes toner leakage. In a toner leakage test of the toner of the present disclosure, the time taken to observe the toner leakage is preferably 17 hours or more, more preferably 18 hours or more, still more preferably 19 hours or more, and even more preferably 20 hours or more, and the toner leakage test is performed as follows: after the toner is left for 24 hours in a high temperature and high humidity environment, a printer filled with the toner repeats the cycle of running for 10 seconds and then stopping for 10 seconds in the same environment.

The toner leakage test and the observation of the toner leakage can be carried out by the same method as the toner leakage evaluation described below under “Examples”.

The toner of the present disclosure is excellent in thin line reproducibility. In a thin line reproducibility test of the toner of the present disclosure, the number of sheets that can keep a line width difference of 10 μm or less compared to the line image printed on the first sheet, is preferably 8000 or more, more preferably 9000 or more, and still more preferably 10000 or more, and the thin line reproducibility test is performed as follows: after the toner of the present disclosure is left for 24 hours in a low temperature and low humidity environment, a line image of 2×2 dot line (width 85 μm) is continuously formed in the same environment.

The thin line reproducibility test and the measurement of the line width of the line image can be carried out by the same method as the thin line reproducibility evaluation described below under “Examples”.

### EXAMPLES

Hereinafter, the present disclosure will be described further in detail, with reference to Examples and Comparative However, the present disclosure is not limited to Examples.

these examples. Herein, part(s) and & are on a mass basis unless otherwise noted.

### Example 1

### 1. Production of Colored Resin Particles

### 1-1. Preparation of Polymerizable Monomer Composition for Core

First, 77 parts of styrene and 23 parts of n-butyl acrylate as polymerizable monomers, and 7 parts of carbon black as a black colorant, were dispersed by means of an in-line type emulsifying and dispersing machine (product name: MILDER, manufactured by: Pacific Machinery & Engineering Co., Ltd.), thereby obtaining a polymerizable monomer mixture.

To the polymerizable monomer mixture, 1.6 parts of a charge control resin (a quaternary ammonium salt group-containing copolymer) as a charge control agent, 5 parts of hexaglycerin octabehenate (melting point 70° C.) and 5 parts of a paraffin wax (melting point 68° C.) as release agents, 0.3 parts of a polymethacrylic acid ester macromonomer (product name: AA-6, manufactured by: Toagosei Co., Ltd.) as a macromonomer, 0.6 parts of divinylbenzene as a crosslinkable polymerizable monomer, and 1.5 parts of t-dodecyl mercaptan as a molecular weight modifier, were added. They were mixed and dissolved while heating them at 45° C., thereby preparing a polymerizable monomer composition for core.

### 1-2. Preparation of Aqueous Dispersion Medium

An aqueous solution of 6.2 parts of sodium hydroxide (alkali metal hydroxide) dissolved in 50 parts of deionized water, was gradually added to an aqueous solution of 10.2 parts of magnesium chloride (water-soluble polyvalent metal salt) dissolved in 250 parts of deionized water, while stirring at room temperature, thereby preparing a magnesium hydroxide colloid (hardly water-soluble metal hydroxide colloid) dispersion.

### 1-3. Suspension Step (Droplets Forming Step)

At room temperature, the polymerizable monomer composition for core was added to the magnesium hydroxide the mixture was stirred. colloidal dispersion, and As a polymerization initiator, 4.4 parts of t-butylperoxy diethylacetate was added thereto. Then, the thus-obtained mixture was subjected to high-speed shearing and stirring at a rotational frequency of 15,000 rpm for 10 minutes, by use of an in-line type emulsifying and dispersing machine (product name: MILDER, manufactured by: Pacific Machinery & Engineering Co., Ltd.) Accordingly, a suspension was obtained, in which the droplets of the polymerizable monomer composition for core were dispersed.

### 1-4. Polymerization Step

The suspension was put in a reactor furnished with stirring blades and stirred at 50° C. for 5 minutes at 250 rpm (the tip speed of the stirring blades: 0.90 m/s). Then, the temperature of the suspension was increased to 90° C. to initiate a polymerization reaction. When a polymerization conversion rate reached almost 100%, 2 parts of methyl methacrylate as a polymerizable monomer for shell, and 0.3 parts of 2,2′-azobis(2-methyl-N-(2-hydroxyethyl)-propionamide) (product name: VA-086, manufactured by: Wako Pure Chemical Industries, Ltd., water-soluble) as a polymerization initiator for shell, which was dissolved in 10 parts of deionized water, were added to the reactor. The reaction was continued for 4 hours at 90° C. Then, the reaction was stopped by water-cooling the reactor, thereby obtaining an aqueous dispersion of colored resin particles having a core-shell type structure. The tip speed of the stirring blade was kept until the polymerization reaction of the shell was stopped.

### 1-5. Post-Treatment Step

While stirring the aqueous dispersion of the colored resin particles, the aqueous dispersion was subjected to acid washing by adding sulfuric acid in a dropwise manner at room temperature, until the pH of the aqueous dispersion reached 6.5 or less. Next, the aqueous dispersion was subjected to filtration separation. Then, a solid matter thus obtained was mixed with 500 parts of deionized water, re-slurried, repeatedly subjected to a water washing treatment (washing, filtering and dehydrating) several times, and then subjected to filtration separation. A solid matter thus obtained was put in the container of a dryer and dried at 45° C. for 48 hours, thereby obtaining colored resin particles.

### 2. Production of Toner

To 100 parts of the colored resin particles obtained above, the following particles were added as the external additive.

Silica fine particles having a number average primary particle diameter of 50 nm (product name: H05TA, manufactured by: Clariant Corporation): 1.3 parts

Silica fine particles having a number average primary particle diameter of 20 nm (product name: TG-7120, manufactured by: Cabot Corporation): 0.5 parts

Silica fine particles having a number average primary particle diameter of 7 nm (product name: TG-820F, manufactured by: Cabot Corporation): 0.2 parts

Zinc stearate fine particles having a number average primary particle diameter of 0.5 μm (product name: SPZ-100F, manufactured by: Sakai Chemical Industry Co., Ltd.): 0.1 parts

External addition treatment was performed by mixing the particles by means of a high-speed stirring machine (product name: FM MIXER, manufactured by: Nippon Coke & Engineering Co., Ltd.) under the following conditions, thereby preparing the toner of Example 1: the peripheral speed of the stirring blades was 32.2 m/s, and the external addition treatment time was 6.0 min.

### Examples 2, 4, 6 and 7 and Comparative Examples 1 and 2

The toners of Examples 2, 4, 6 and 7 and the toners of Comparative Examples 1 and 2 were obtained in the same manner as Example 1, except that in “1-4. Polymerization step”, the stirring conditions before increasing the temperature of the suspension to 90° C., that is, before initiating the polymerization reaction were changed according to Table 1, and the tip speed of the stirring blades shown in Table 1 was kept until the polymerization reaction was stopped.

### Example 3

The toner of Example 3 was obtained in the same manner as Example 1, except for the following: in “1-2. Preparation of aqueous dispersion medium”, the amount of the added magnesium chloride was changed to 12.5 parts, and the amount of the added sodium hydroxide was changed to 7.6 parts; in “1-4. Polymerization step”, the stirring conditions before increasing the temperature of the suspension to 90° C., that is, before initiating the polymerization reaction were changed according to Table 1, and the tip speed of the stirring blades shown in Table 1 was kept until the polymerization reaction was stopped; and in “2. Toner production”, the amount of the added silica fine particles having a number average primary particle diameter of 50 nm (product name: H05TA, manufactured by: Clariant Corporation) was changed to 2.3 parts, and the amount of the added silica fine particles having a number average primary particle diameter of 20 nm (product name: TG-7120, manufactured by: Cabot Corporation) was changed to 0.8 parts.

### Example 5

The toner of Example 5 was obtained in the same manner as Example 1, except for the following: in “1-2. Preparation of aqueous dispersion medium”, the amount of the added magnesium chloride was changed to 8.2 parts, and the amount of the added sodium hydroxide was changed parts; in “1-4. to 5.0 Polymerization step”, the stirring conditions before increasing the temperature of the suspension to 90° C., that is, before initiating the polymerization reaction were changed according to Table 1, and the tip speed of the stirring blades shown in Table 1 was kept until the polymerization reaction was stopped; and in “2. Toner production”, the amount of the added silica fine particles having a number average primary particle diameter of 50 nm (product H05TA, name: manufactured by: Clariant Corporation) was changed to 0.8 parts, and the amount of the added silica fine particles having a number average primary particle diameter of 20 nm (product name: TG-7120, manufactured by: Cabot Corporation) was changed to 0.3 parts.

### Comparative Example 3

The toner of Comparative Example 3 was obtained in the same manner as Example 1, except for the following: in “1-2. Preparation of aqueous dispersion medium”, the amount of the added magnesium chloride was changed to 14.0 parts, and the amount of the added sodium hydroxide was changed to 8.5 parts; in “1-4. Polymerization step”, the stirring conditions before increasing the temperature of the suspension to 90° C., that is, before initiating the polymerization reaction were changed according to Table 1, and the tip speed of the stirring blades shown in Table 1 was kept until the polymerization reaction was stopped; and in “2. Toner production”, the amount of the added silica fine particles having a number average primary particle diameter of 50 nm (product name: H05TA, manufactured by: Clariant Corporation) was changed to 2.4 parts, and the amount of the added silica fine particles having a number average primary particle diameter of 20 nm (product name: TG-7120, manufactured by: Cabot Corporation) was changed to 0.9 parts.

### Comparative Example 4

The toner of Comparative Example 4 was obtained in the same manner as Example 1, except for the following: in “1-2. Preparation of aqueous dispersion medium”, the amount of the added magnesium chloride was changed to 6.5 parts, and the amount of the added sodium hydroxide was changed to 4.0 parts; in “1-4. Polymerization step”, the stirring conditions before increasing the temperature of the suspension to 90° C., that is, before initiating the polymerization reaction were changed according to Table 1, and the tip speed of the stirring blades shown in Table 1 was kept until the polymerization reaction was stopped; and in “2. Toner production”, the amount of the added silica fine particles having a number average primary particle diameter of 50 nm (product name: H05TA, manufactured by: Clariant Corporation) was changed to 0.7 parts, and the amount of the added silica fine particles having a number average primary particle diameter of 20 nm (product name: TG-7120, manufactured by: Cabot Corporation) was changed to 0.3 parts.

### Example 8

The toner of Example 8 was obtained in the same manner as Example 1, except for the following: “1-1. Preparation of polymerizable monomer composition for core” was changed as described below, and in “1-4. Polymerization step”, the stirring conditions before increasing the temperature of the suspension to 90° C., that is, before initiating the polymerization reaction were changed according to Table 1, and the tip speed of the stirring blades shown in Table 1 was kept until the polymerization reaction was stopped.

In Example 8, the procedure of the preparation of the polymerizable monomer composition for core was as follows.

First, 72 parts of styrene and 28 parts of n-butyl acrylate as polymerizable monomers, 9 parts of carbon black as a black colorant, and 1.0 part of a methyl methacrylate/ethyl acrylate/acrylic acid copolymer (Tg: 76° C., acid value: 2.6 mgKOH/g) as a polar resin were dispersed by means of an in-line type emulsifying and dispersing machine (product name: MILDER, manufactured by: Pacific Machinery & Engineering Co., Ltd.), thereby obtaining a polymerizable monomer mixture.

To the polymerizable monomer mixture, 1.6 parts of a charge control resin (a quaternary ammonium salt group-containing copolymer) as a charge control agent, 20 parts of behenyl stearate (melting point 67° C.) as a release agent, 0.6 parts of divinylbenzene as a crosslinkable polymerizable monomer, and 1.5 parts of t-dodecyl mercaptan as a molecular weight modifier, were added. They were mixed and dissolved while heating them at 45° C., thereby preparing a polymerizable monomer composition for core.

### 3. Measurement of the Toner

A mixed solution obtained by adding 0.10 g to 0.12 g of the toner to a linear alkylbenzene sulfonate aqueous solution (concentration 0.3%) was subjected to a dispersion treatment for 5 minutes by an ultrasonic cleaner, thereby preparing a measurement sample. Using a flow particle image analyzer (product name: IF-3200, manufactured by: JASCO International Co., Ltd.), the toner particles contained in the measurement sample were measured in the following measurement conditions. The number of the toner particles contained in the measurement sample increased as the particle diameter of the toner particles decreased. However, in all of the examples and the comparative examples, the number of the toner particles in the measurement sample was in a range of from 1000 to 3000.

### (Measurement Conditions)

Thickness of the spacer of a flow cell: 50 μm
Telecentric zoom lens magnification: 4.5×
Total magnification: 9.0×
Measured amount: 0.5 mL
Image resolution: 0.185 μm/pixel
Detection algorithm: Ghost detection
Threshold: 15%

### 3-1. Equivalent Circular Area Diameter

The equivalent circular area diameter of each toner particle was measured. The arithmetic average of the equivalent circular area diameters of the measured particles was defined as the equivalent circular area diameter of the toner.

### 3-2. Compactness

The equivalent circular area diameter and maximum length of each toner particle were measured, and the compactness of the toner particle was calculated by the following formula. The arithmetic average of the compactness values of the measured particles was defined as the compactness of the toner.

Compactness=Equivalent circular area diameter/Maximum length

### 3-3. Maximum Inscribed Circle Diameter/Equivalent Circular Area Diameter Ratio

The maximum inscribed circle diameter and equivalent circular area diameter of each toner particle were measured. The maximum inscribed circle diameter was divided by the equivalent circular area diameter to obtain a value (the maximum inscribed circle diameter/the equivalent circular area diameter). The arithmetic average of the resulting values of the measured particles was defined as the maximum inscribed circle diameter/equivalent circular area diameter ratio of the toner.

### 3-4. Circularity

The equivalent circular area diameter and equivalent circular perimeter diameter of each toner particle were measured, and the circularity of the toner particle was calculated by the following formula. The arithmetic average of the circularities of the measured particles was defined as the circularity of the toner.

Circularity=Equivalent circular area diameter/Equivalent circular perimeter diameter

### 4. Evaluation of the Toner

### 4-1. Toner Leakage

The following toner leakage test was carried out by use of a modified commercially-available, non-magnetic, one-component development printer (print speed: 40 sheets/min). First, the toner was filled in the toner cartridge of the printer, and then, the toner cartridge was left in a high temperature and high humidity (H/H) environment (temperature: 32.5″C, humidity: 80% RH) for 24 hours. Next, in the same environment, the toner cartridge was set in the printer, and the toner leakage test was carried out by causing the printer to repeat a cycle of running for 10 seconds and then stopping for 10 seconds for a total of 20 hours. At this time, the seal portions between the casing of the developing cartridge and both axial ends of the developing roller, were observed every two hours to check the presence and absence of toner leakage.

This test was carried out three times. The average of the time taken to observe toner leakage was calculated and defined as the toner leakage time. The toner with a long toner leakage time means that is toner hardly causes toner leakage. Of the test results shown in Table 1, “>20” indicates that toner leakage was not observed even after the toner leakage test of 20 hours.

### 4-2. Thin Line Reproducibility

The toner was filled in the toner cartridge of a commercially-available, non-magnetic, one-component development printer (print speed: 24 sheets/min). Copier paper sheets were set in the printer. After the printer was left in a low temperature and low humidity (L/L) environment (temperature: 10° C., humidity: 20% RH) for 24 hours, a thin line reproducibility test was carried out in the same environment, in which a line image of 2×2 dot line (width 85 μm) was continuously formed. The concentration distribution data of the line image was collected by measuring every 500 sheets by a printing evaluation system (product name: RT2000, manufactured by: YA-MA Inc.) At this time, the full width at half the maximum concentration value was defined as the line width. The line width of the line image printed on the first sheet was used as a standard. A line image with a line width difference of 10 μm or less from the standard, was considered as a reproduction of the line image of the first printed sheet. Based on this criteria, the number of sheets on which the line image could keep a line width difference of 10 μm or less from the standard, was checked by printing up to 10, 000 sheets. Of the test results shown in Table 1, “>10000” indicates that the line image fulfilling the criteria could be kept even after the thin line reproducibility test was carried out on up to 10,000 sheets, and the thin line reproducibility of the toner was excellent.

TABLE 1

| | | Exam- | Exam- | Exam- | Exam- | Exam- | Exam- | Exam- | Exam- |
|---|---|---|---|---|---|---|---|---|---|
| | | ple 1 | ple 2 | ple 3 | ple 4 | ple 5 | ple 6 | ple 7 | ple 8 |
| Stirring | Temperature (° C.) | 50 | 50 | 50 | 50 | 50 | 50 | 50 | 50 |
| conditions | Stirring time (min) | 5 | 180 | 180 | 180 | 180 | 360 | 480 | 180 |
| before | Rotational | 250 | 250 | 450 | 450 | 450 | 250 | 450 | 250 |
| initiating | frequency (rpm) | | | | | | | | |
| polymerization | Tip speed (m/s) | 0.9 | 0.9 | 1.6 | 1.6 | 1.6 | 0.9 | 1.6 | 0.9 |
| reaction | | | | | | | | | |
| Toner | Equivalent circular | 7.5 | 7.5 | 5.0 | 7.5 | 9.2 | 7.5 | 7.5 | 7.5 |
| measurement | area diameter (μm) | | | | | | | | |
| results | Circularity | 0.942 | 0.933 | 0.931 | 0.930 | 0.943 | 0.930 | 0.928 | 0.940 |
| | Compactness | 0.955 | 0.943 | 0.933 | 0.931 | 0.931 | 0.925 | 0.919 | 0.944 |
| | Maximum inscribed | 0.946 | 0.929 | 0.919 | 0.913 | 0.918 | 0.909 | 0.902 | 0.938 |
| | circle diameter/ | | | | | | | | |
| | Equivalent circular | | | | | | | | |
| | area diameter | | | | | | | | |
| Toner | Toner leakage time | >20 | >20 | 18 | >20 | >20 | 19 | 17 | >20 |
| evaluation | (hr) | | | | | | | | |
| results | Thin line | >10000 | >10000 | >10000 | >10000 | 9000 | 9000 | 8000 | >10000 |
| | reproducibility | | | | | | | | |

| | | Comparative | Comparative | Comparative | Comparative |
|---|---|---|---|---|---|
| | | Example 1 | Example 2 | Example 3 | Example 4 |
| Stirring | Temperature (° C.) | 50 | 50 | 50 | 50 |
| conditions | Stirring time (min) | 840 | 840 | 480 | 180 |
| before | Rotational | 250 | 450 | 250 | 250 |
| initiating | frequency (rpm) | | | | |
| polymerization | Tip speed (m/s) | 0.9 | 1.6 | 0.9 | 0.9 |
| reaction | | | | | |
| Toner | Equivalent circular | 7.5 | 7.5 | 4.8 | 10.2 |
| measurement | area diameter (μm) | | | | |
| results | Circularity | 0.918 | 0.932 | 0.924 | 0.947 |
| | Compactness | 0.912 | 0.870 | 0.918 | 0.938 |
| | Maximum inscribed | 0.890 | 0.841 | 0.899 | 0.924 |
| | circle diameter/ | | | | |
| | Equivalent circular | | | | |
| | area diameter | | | | |
| Toner | Toner leakage time | 8 | 9 | 12 | >20 |
| evaluation | (hr) | | | | |
| results | Thin line | 7000 | 6000 | >10000 | 7000 |
| | reproducibility | | | | |

### Consideration

As for the toners of Comparative Examples 1 and 2, since the compactness was less than 0.915, the toner leakage time was short; toner leakage easily occurred; and the thin line reproducibility was poor. It is estimated that in Comparative Examples 1 and 2, since the suspension was stirred for too long a time before initiating the polymerization reaction, the compactness of the toners decreased.

As for the toner of Comparative Example 3, since the equivalent circular area diameter was less than 5.0 μm, the toner leakage time was short, and toner leakage easily occurred.

As for the toner of Comparative Example 4, since the equivalent circular area diameter was more than 10.0 μm, the thin line reproducibility was poor.

As for the toners of Examples 1 to 8, the equivalent circular area diameter was 5.0 μm or more and 10.0 μm or less, and the compactness was 0.915 or more and 1.000 or less. Accordingly, the toner leakage time was long; toner leakage was suppressed; and the thin line reproducibility was also excellent.

1. A toner comprising colored resin particles containing a binder resin, a colorant and a release agent, and an external additive,
wherein an equivalent circular area diameter of the toner, which is an average value, is 5.0 um or more and 10.0 μm or less, and a compactness of the toner, which is obtained as a ratio of an equivalent circular area diameter to a maximum length (the equivalent circular area diameter/the maximum length) and which is an average value, is 0.915 or more and 1.000 or less, both of which are measured by a flow particle image analyzer.

2. The toner according to claim 1, wherein a ratio of a maximum inscribed circle diameter to an equivalent circular area diameter (the maximum inscribed circle diameter/the equivalent circular area diameter) of the toner. which is an average value. is 0.900 or more and 0.950 or less.

3. The toner according to claim 1, wherein a circularity of the toner, which is an average value, is 0.900 or more and 0.950 or less.

4. The toner according to claim 1, wherein inorganic fine particles having a number average primary particle diameter of from 6 nm to 100 nm and organic fine particles are contained as the external additive, and a content of the organic fine particles is 0.05 parts by mass or more and 1.0 part by mass or less, with respect to 100 parts by mass of the colored resin particles.

5. The toner according to claim 4, wherein a content of the inorganic fine particles having a number average primary particle diameter of from 6 nm to 100 nm is 0.5 parts by mass or more and 6.5 parts by mass or less, with respect to 100 parts by mass of the colored resin particles.

6. The toner according to claim 4, wherein the inorganic fine particles having a number average primary particle diameter of from 6 nm to 100 nm contain two or more kinds selected from the group consisting of inorganic fine particles A having a number average primary particle diameter of from 36 nm to 100 nm, inorganic fine particles B having a number average primary particle diameter of from 15 nm to 35 nm, and inorganic fine particles C having a number average primary particle diameter of from 6 nm to 14 nm.
